(19) United States
(12) Patent Application Publication
(10) Pub. No.: US 2012/0067147 A1
(43) Pub. Date: Mar. 22, 2012

(54) BEVEL GEARING DEVICE FOR STIRRING RACK OF TINTING MACHINE

(75) Inventors: Song HUANG, Zhengzhou City (CN); Shuangfeng Tang, Zhengzhou City (CN); Zhicheng Liu, Zhengzhou City (CN); Lixin Tang, Zhengzhou City (CN)

(73) Assignee: Ruhua SHEN, Zhengzhou City (CN)

(21) Appl. No.: 13/234,437

(22) Filed: Sep. 16, 2011

Related U.S. Application Data
(63) Continuation of application No. PCT/CN2010/000359, filed on Mar. 23, 2010.

(30) Foreign Application Priority Data
Mar. 23, 2009 (CN) 200910064436.6

(51) Int. Cl. F16H 55/20; F16H 55/06; F16H 1/14

(52) U.S. Cl. 74/409; 74/417

(57) ABSTRACT

A bevel gearing device for stirring rack of a tinting machine, including a gear bracket fixedly mounted on the stirring rack; a horizontal drive shaft rotationally mounted on the gear bracket; a first bevel gear fixedly mounted on the horizontal drive shaft adjacent to a side of gear bracket; a vertical rotational shaft with a second bevel gear fixedly mounted on its upper end and a stirring paddle mounted on its lower end, said stirring paddle is placed in a paint bucket; wherein an open guide slot is provided at the bottom of the gear bracket, the guide slot includes a first segment extending perpendicular to the horizontal drive shaft and a second segment extending towards the first bevel gear, an angle between the first and second segment is 180°≧α≧160°.

### CROSS REFERENCE TO RELATED APPLICATION

This application is a continuation application filed under 35 U.S.C. §111(a), claiming benefit under 35 U.S.C. §120 and §365(c) of a PCT International Application Number PCT/CN2010/000359, filed Mar. 23, 2010, it being further noted that foreign priority benefit is based on Chinese Patent Application 200910064436.6, filed Mar. 23, 2009 in the State Intellectual Property Office of P.R. China, the disclosures of which are thereby incorporated by reference.

### TECHNICAL FIELD

Embodiments of the invention relate to a stirring rack of a tinting machine suitable for color matching and paint stirring in the vehicle maintenance industry, especially to a separable bevel gearing device of the stirring rack.

### BACKGROUND ART

Currently, in the vehicle maintenance industry, there is a strict and accurate requirement for the paint color as to spray painting and repairing paint color on the automobile outer casing surface. To ensure the desired color-matching paint uniformly and no color cast in the original bucket, the paint bucket shall be located on the stirring rack and mixed once in a while. In general, a plurality of paint buckets are located on one stirring rack, each of the buckets is connected with the transmission gear of the stirring rack, and the transmission gear is connected to the main drive device driven by a motor. In turn the stirring paddle within the buckets is driven by the transmission gear to mix the paints in the buckets.

U.S. Pat. No. 5,947,598 discloses a paint stirring device, which is driven by means of an outer teeth belt with better engagement and disengagement performances. However, for this outer teeth belt configuration, the engaged teeth may drop out during the transmission and the cost is high. Furthermore, the outer teeth belt needs to be tightened periodically to ensure a proper tension of the outer teeth belt. Otherwise, the teeth belt will slip and thus cannot transfer the stirring force normally.

Chinese Utility Model Patent ZL96240843.3 discloses a bevel gearing device for a paint-stirring rack, the device includes a gear bracket, a transverse drive shaft, a first bevel gear, a vertical rotational shaft, a second bevel gear and a driving plate fixed on the bottom of the vertical rotational shaft, and a fork that is driven by the drive plate to mix the paints in the bucket. The connecting configuration between the bevel gearing device and the stirring paddle is complex and typically comprises such parts as the drive plate and fork, etc. As a result, the stirring rack is greater in height and thus occupies more space. Meanwhile, the package and transport costs are also increased. In addition, the two engaged bevel gears of the above mentioned bevel gearing device are fixed in the position prior to the operation of the equipment, and there needs a accurate position control between the two gears. This is because of a higher requirement for the installation position of the conventional bevel gearing pairs in the mechanical design and installment, such that the three-dimensional installation positions of the engaged gears in the gear bracket should reach a desired accuracy. Thus, the bevel gearing pairs, especially the bevel gearing pairs for smooth transmission and small noise, require a pair of fine-manufactured bevel gears being installed at the accurate engagement position. Furthermore, the relative three-dimensional position accuracy of two bevel gears shall be finely adjusted to ensure the accurate engagement of the gears. In other words, the back cones of the gears shall be leveled and a certain gear backlash shall be ensured. When installing the bevel gears, a pair of gears to be engaged are generally installed and fixed in the proper position, and then the transmission of motive force is loaded on the bevel gears. The assembly accuracy is hard to be ensured, especially when a driven gear is not specially made for a certain pair but random matches with one of bevel gears. Usually, the user is not allowed to plug a bevel gear in a rotating bevel gear from the lateral of the latter for engaging and rotating with, which will result in heavy gear grinding or gear collision, etc.

### SUMMARY

In light of the problems discussed above, an embodiment of the invention is to provide a separable bevel gearing device for the stirring rack of the tinting machine with the characteristics of simple structure, stable transmission performance, user friendliness and cost-effectiveness. Moreover, a smooth engagement or disengagement of the bevel gearing device can be achieved during the running or stopping of the stirring rack.

Accordingly, an aspect of the invention provides a bevel gearing device for the stirring rack of tinting machine, which includes a gear bracket fixedly mounted on the stirring rack; a horizontal drive shaft rotationally mounted on the gear bracket; a first bevel gear fixedly mounted on the horizontal drive shaft adjacent to a side of the gear bracket; a vertical rotational shaft with a second bevel gear fixedly mounted on its upper end and a stirring paddle mounted on its lower end, said paddle is placed in a paint bucket; wherein an open guide slot is provided at the bottom of the gear bracket, the guide slot includes a first segment extending perpendicular to the horizontal drive shaft and a second segment extending towards the first bevel gear, an angle between the first segment and the second segment is 180≧α≧160°, and the size of guide slot is designed to slidably receive the vertical rotational shaft and let the latter in position at the innermost part of the guide slot, such that the second bevel gear is releasably engaged with the first bevel gear, the rotation direction of the first bevel gear may be selected such that it can drive the second bevel gear to rotate inward during the operation of the stirring rack of tinting machine. Further, at least one of the first and second bevel gears is made of plastic material.

Additionally, during the operation of the stirring rack, i.e. during stirring the paints in the paint bucket, the rotation direction of the first bevel gear should be selected such that it can drive the second bevel gear to rotate inwardly, in other words, the teeth on the lower part of the first bevel gear moves backwards when viewing from the front of stirring rack. As such, during the rotation of the first bevel gear, the second bevel gear will be inserted more easily, and the inserted second bevel gear driven by the first bevel gear will always be in the proper engagement position and not slip out. More advantageously, in this configuration, the first and the second bevel gears may be disengaged during the stirring to take off a desired paint bucket.

In another aspect of this invention, the guide slot of such configuration may firstly make the vertical rotational shaft be inserted perpendicular to the horizontal shaft along the first segment of the guide slot, shortly before second bevel gear contacts with the first bevel gear, the moving direction of the vertical rotational shaft is transferred to a direction along the second segment of the guide slot towards the first bevel gear. By means of this inserting manner, there will not appear such problems as heavy gear grinding or gear collision when the second bevel gear is inserted into the first bevel gear, and thus the second bevel gear is inserted easily. Furthermore, the innermost part the guide slot is preferably configured such that the central line thereof is overlapped completely with the axis of the vertical rotational shaft when the first and the second bevel gears is engaged. Advantageously, the width of the guide slot may be selected to achieve a loose fit between the guide slot and the vertical rotational shaft, such configuration not only make the vertical rotational shaft to be inserted easily, but also ensure application safety.

According to a preferable aspect of the invention, both of the first and second bevel gears are made of plastic material. Replacing metal bevel gear with plastic bevel gear not only reduces the accuracy requirement for assembling position, but also reduces the noise of the bevel gear pairs during operation. Moreover, the anti-abrasion effects are achieved without the lubrication between the two plastic gears. More advantageously, in order to improve the wear resistance of the plastic bevel gears, the plastic bevel gear is mixed with anti-attrition substance such as molybdenum disulfide etc. to decrease the friction factor of the gears.

According to a preferable aspect of the present invention, the angle between the first and second segments of the guide slot is 170≧α≧160°, thereby the insertion and engagement of the bevel gears is easier. In addition, for facilitating the insertion of the bevel gears, the first and second bevel gears are configured such that the minimum value of the gear backlash thereof increases along with the increasing angle α, and the first and second bevel gears have a modulus m=1.5˜4, the minimum value of gear backlash is in the range of 0 mm-0.3 mm, said value of gear backlash is about two times or more of gear backlash in the bevel gears with higher accuracy in the prior art. Preferably, the minimum value of gear backlash is 0 mm, if α=160°; the minimum value of gear backlash is 0.3 mm, if α=180°.

According to an aspect of the invention, the bevel gearing device is preferably provided with a reducer, by which the rotation speed of the horizontal drive shaft may be maintain in the range of 60˜95 rpm. Under this speed, the thermal deformation caused by the friction of the two bevel gears will be prevented and the running noise is relatively lower. However, one skilled in the art will be appreciated that the separable bevel gearing device of the present invention may also have a higher rotation speed according to the material of the bevel gears, but this will increase manufacturing cost accordingly.

In a preferable aspect of the present invention, a stirring paddle is installed on the vertical rotational shaft slidably, thus in case there are less paints in the bucket, the issues of hanging the bucket in the air or swaying due to the lifting force caused by the paddle are solved. However, one skilled in the art will understand that other proper ways in the art also can be used to avoid such problems.

Moreover, according to an aspect of the invention, the gear bracket is preferably made of plastic material, and the horizontal drive shaft and the vertical rotational shaft are preferably made of metal material. In this way, a desired strength of drive shaft is not only be ensured, but also the friction factor between the metal shaft and the gear bracket is decreased.

According to one aspect of the invention, the vertical rotational shaft is designed to be cylindrical, and the cylindrical structure of vertical rotational shaft facilitates the insertion of the vertical rotational shaft with the second bevel gear. For the convenience of installation, the vertical rotational shaft may be comprised of two segments, which are connected together for example by thread, as well as other suitable means.

The separable bevel gearing device according to an aspect of the invention solves the problem of teeth collision during the insertion and pull-out of a bevel gear while ensures the accuracy of the insertion position for the bevel gear to meet the requirement. In addition, the insertion is user friendly since it could be done at any time as desired. Moreover, the separating configuration of the bevel gears may decrease the overall height of the stirring rack effectively, and thus the package and transport costs are reduced accordingly. Furthermore, by selecting the rotational direction of the horizontal drive shaft properly during stirring, the first bevel gear will bring the vertical rotational shaft into the correct position in the slot, and keep the vertical rotational shaft in right position during rotation. Thus the gearing of the bevel gears is very reliable and the disengagement of the bevel gears will not appear during the stirring. More advantageously, the gear clearance of such bevel gearing device do not need to be adjusted for a long time.

### BRIEF DESCRIPTION OF THE DRAWINGS

Embodiments of the invention will now be described herein below by way of examples, and with reference to the accompanying drawings, in which:

FIG. 1 is a top view of the bevel gearing device according to an aspect of the invention, from which a second bevel gear and a vertical rotational shaft are removed;

FIG. 2 is a perspective view of the bevel gearing device in FIG. 1, from which the second bevel gear and the vertical rotational shaft are removed;

FIG. 3 is a front view of the bevel gearing device according to an aspect of the invention;

FIG. 4 is a perspective view of the bevel gearing device in FIG. 3;

FIG. 5 is an assembly illustration of the bevel gearing device and the bucket lids;

FIG. 6 is an assembly illustration of the bevel gearing device and the buckets;

FIG. 7 is a schematic view shows a stirring rack using the bevel gearing device according to the present invention.

### LIST OF REFERENCE NUMERALS

1—Gear bracket; 2—Horizontal drive shaft; 3—First bevel gear; 4—Vertical rotational shaft; 5—Second bevel gear; 6—Bucket lid; 7—Stirring paddle; 8—Guide slot; 8a—First segment of guide slot; 8b—Second segment of guide slot; 9—Location hole; 10—Bucket; 11—Stirring rack; 12—Supporting Shelf; 13—Locating pin.

### DESCRIPTION OF EMBODIMENTS

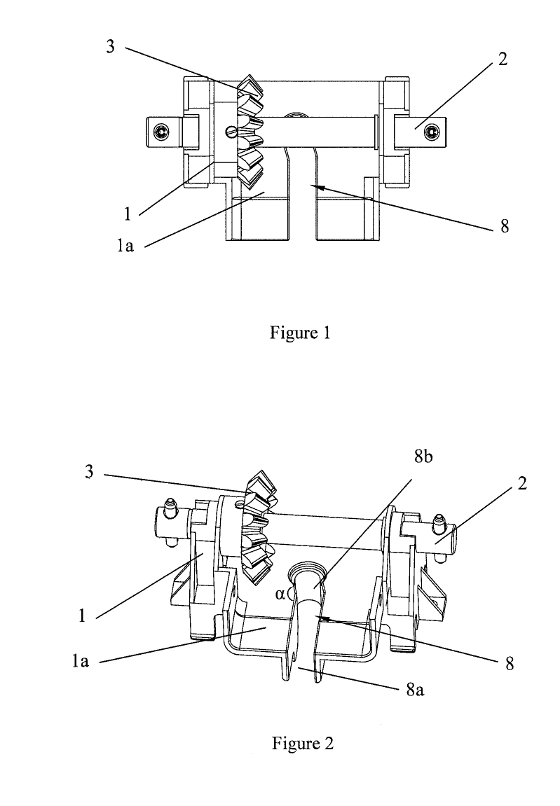

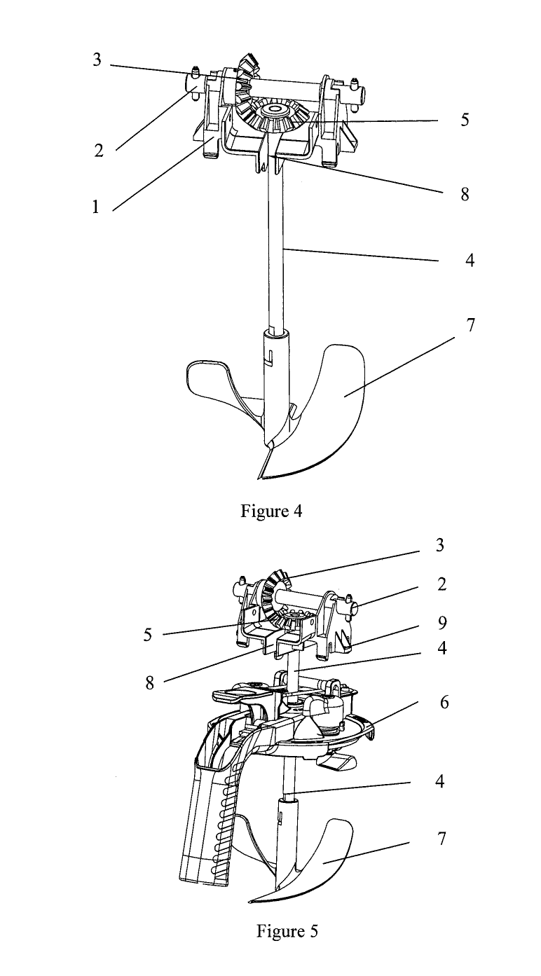

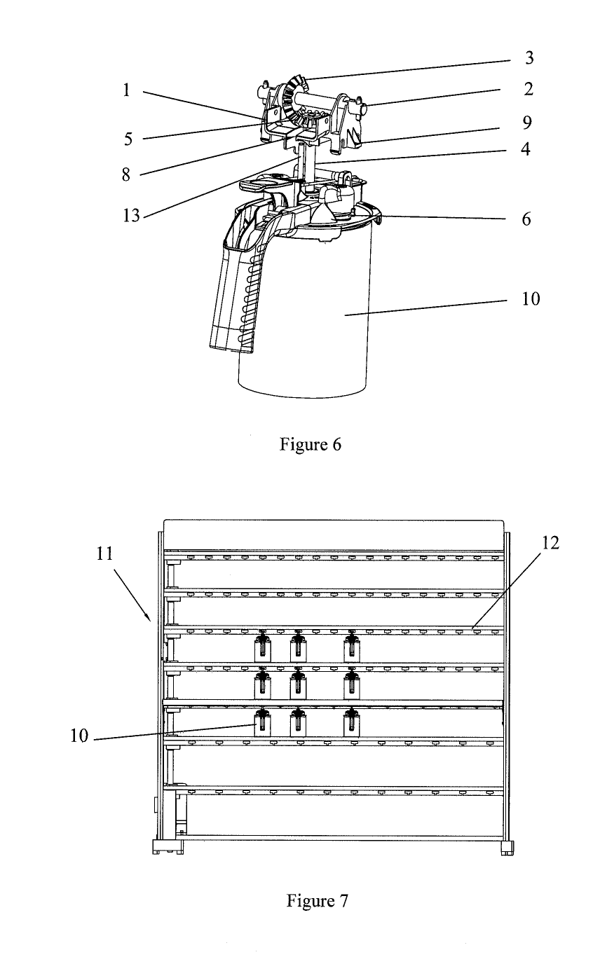

FIGS. 1-6 illustrates an embodiment of a separable bevel gearing device of the present invention suitable for the stirring rack 11 of tinting machine. As shown in these figures, the bevel gearing device includes a gear bracket 1, which is mounted fixedly on the stirring rack 11 by means of location holes 9 therein (see FIG. 5). A horizontal drive shaft 2 driven by the driving device may be mounted rotatably in openings in the gear bracket 1. The length of the horizontal drive shaft 2 (here only schematically shown) is almost the same with the width of the stirring rack 11. The drive shaft may extend across several gear brackets 1 spaced apart the same distance on the stirring rack. For simplicity, only one group of drive bevel gears is described herein. A first bevel gear 3 is installed fixedly on the horizontal drive shaft 2 at its side adjacent to the gear bracket 1, such that the first bevel gear 3 rotates simultaneously with the horizontal drive shaft 2. The bevel gearing device further includes a vertical rotational shaft 4 which is perpendicular to the supporting shelf 12 after installation. The vertical rotational shaft 4 is provided with a second bevel gear 5 mounted fixedly its upper end and a stiffing paddle 7 on its lower end. Actually, the vertical rotational shaft 4 shall extend through a central hole in the bucket lid 6, and then the stirring paddle 7 is installed. As shown in FIGS. 5 and 6, the bucket lid 6 is located on a shaft lever of the vertical rotational shaft 4 between the second bevel gear 4 and the stirring paddle 7.

Advantageously, as shown in FIGS. 1 and 2, a guide plate is provided at the bottom of the gear bracket 1 preferably made of the plastic material, and the guide plate has an open guide shot 8, the guide slot 8 includes a first segment 8a extending perpendicular to the horizontal drive shaft 2 and a second segment 8b extending towards the first bevel gear 3, wherein an angle between the first and second segment is 180≧α≧160° (i.e. the guide slot may be a straight slot), preferably 170≧α≧160°. Meanwhile, the width of the guide slot 8 may be designed to slidably receive the vertical rotational shaft 4, and hold the shaft 4 at the innermost part of the guide slot 8 in position, such that the vertical rotational shaft 4 installed rotatably in the bucket lid 6 and the second bevel gear 5 fixed on the rotational shaft 4 may be easily inserted into the guide slot 8, and thus the second bevel gear 5 is able to releasably engaged with the first bevel gear 3.

In an embodiment of the invention, the width of the guide slot 8 should be selected to achieve a loose fit between the guide slot and the vertical rotational shaft 4. Particularly, in a embodiment, the diameter of the vertical rotational shaft 4 is e.g. 8 mm, the width of the first segment 8a of the guide slot is 9 mm, and the width of the second segment 8b of the guide slot is 8.4 mm, such configuration not only makes the vertical rotational shaft 4 inserted easily, but also facilitates to keep it in position, thus ensures the operation safety. Furthermore, the two bevel gears are configured such that the minimum value of gear backlash thereof increases along with the increasing angle α. Preferably, the first and second bevel gears are designed to have a modulus m=1.5˜4, and the minimum value of gear backlash is in the range of 0 mm—0.3 mm when assembling. For example, the minimum value of gear backlash is 0 mm, if α=160°; the minimum value of gear backlash is 0.3 mm, if α=180°. Such values of gear backlash can not only achieve normal engagement of the separated bevel gears, but also increase their working life.

As mentioned above, during the insertion of a paint bucket 10, the guide slot 8 is configured such that the vertical rotational shaft 4 is firstly inserted perpendicular to the horizontal drive shaft fixed with the first bevel gear 3, before the second bevel gear is to contact with the first bevel gear, the insertion direction of the vertical rotational shaft is changed to a direction along the second segment 8b of the guide slot, which is towards and adjacent to the first bevel gear 3. In this case, the paint bucket may be inserted and pulled out easily when the stirring rack stops. The second bevel gear can be surely inserted into a proper position to engage with the first bevel gear when the stirring rack is running. In addition, there will not appear problem of unwilling disengagement during the stirring process.

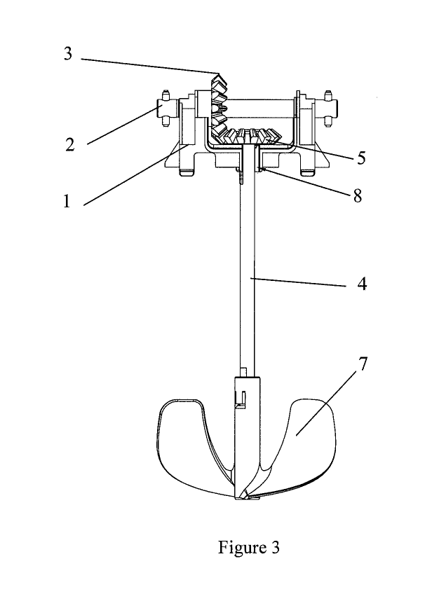

Specifically, during the operation process of the stirring rack, i.e. when stirring the paints, the rotation direction of the horizontal drive shaft 2 and the first bevel gear 3 thereon should be selected such that the first bevel gear may drive the second bevel gear 5 to rotate inward, as shown in FIG. 3, the rotation direction of the second bevel gear is clock-wise. Therefore, when the bucket with the vertical rotational shaft 4 and the second bevel gear 5 is inserted into the open guide slot 8, the rotation of the first bevel gear 3 will drive the second bevel gear 5 into the innermost part of the guide slot 8 and maintain the vertical rotational shaft 4 against the innermost part of the second segment 8a of the guide slot 8, and thus the correct position of the second bevel gear 5 on the horizontal direction is ensured. In addition, because the bottom of the second bevel gear 5 contacts with the guide plate surface at the open guide slot 8 of the gear bracket 1, and the bucket 10 is well positioned on the stirring rack 11, which make the second bevel gear 5 on the upper end of the rotational shaft (the shaft of the stirring paddle 7) be in a right vertical position. As a result, the pair of bevel gears 3, 5 are maintain in a proper engagement position. When the bucket 10 is to be pulled out, one may just grips a handle on the bucket lid 6 by hand and pulls it with small force, the bucket 10 will be pulled out by an instantaneous accelerating rotation of the second bevel gear 5 with the stirring paddle 7. One skilled in the art would understand that the resistance force to be overcome when pulling out the paint bucket not only depends on the viscosity of the paints, but also on the structure of the stirring paddle 7 which can be adjusted as desired.

In an embodiment of the invention, the gear bracket 1 is preferably made of plastic material. Moreover, the two bevel gears are preferably made of plastic material such as nylon material, so as to facilitate the engagement between the bevel gears. In this case, not only the accuracy requirement for the assembly position but also the operation noise generated by the bevel gear pairs is reduced. One skilled in the art would appreciate that the bevel gears in the present invention may be made of other suitable material, such as metaformaldehyde and polycarbonate etc. However, these materials have disadvantages of higher cost and higher rigidity. Furthermore, the bevel gears may also be made of mixed rubber and plastic materials. Advantageously, for improving the abrasion resistance of the plastic bevel gears, the plastic materials are mixed with anti-attrition substance such as molybdenum disulfide and so on to decrease the friction factor of the gears. Since the driven bevel gear often needs to be pulled out, and the lubricating oil on the surface would contaminate the environment. While the smooth operation and anti-attrition effects are ensured, the bevel gears in the present invention needs no lubrication during its operation, thus the foregoing issue is resolved.

According to one aspect of the invention, a stirring paddle 7 is installed on the vertical rotational shaft slidably, thus in case there are less paints in the bucket, the issues of hanging the bucket in the air or swaying due to the lifting force caused by the paddle are solved. Therefore, when stirring the paints, the stirring paddle would slide downward to the bottom of the bucket when it drives the paints upward, then the lifting and swaying of the bucket are limited. However, one skilled in the art will understand that other appropriate ways in the art also can be used to prevent such problems as to the lifting and swaying of the bucket. For example, a shaft extending from the bottom of the guide plate is provided to contact against the edge of the opening on the bucket lid.

For the convenience of installation, the vertical rotational shaft 4 may be comprised of two segments. In an embodiment, the two segments are connected together (for example) by thread. However, the two segments may also be connected together by other suitable means such as snap connection.

In the above mentioned embodiment, both of the horizontal drive shaft 2 and the vertical rotational shaft 4 are made of metal. This is because the metal has good heat dispersion performance and lower frictional coefficient when the drive shaft is installed into the plastic gear bracket 1 as well as good strength.

During the installation, as shown in FIG. 7, the gear bracket 1 may be secured on the supporting shelf 12 by the bolts through the location holes 9 on the gear bracket. A plurality of gear brackets may be installed fixedly on the stirring rack in lines. On the same supporting shelf, the horizontal drive shaft 2 may be a single shaft, or several shafts being connected together.

When the stirring rack is not in operation, when the paint in the bucket 10 is to be stirred, the vertical rotational shaft 4 on the bucket lid 6 will be inserted into the inner part of the guide slot 8 by sliding along the guide slot 8 of the gear bracket 1, and the second bevel gear 5 contacts with the first bevel gear 3, this will cause the second bevel gear 5 rotating anti-clockwise (view from the front in FIG. 3) to realize the insertion of the second bevel gear 5. In case the vertical rotational shaft 4 is inserted into the innermost part of the guide slot, the first bevel gear 3 on the horizontal drive shaft 2 is well engaged with the second bevel gear 5 on the top of the vertical rotational shaft 4. To pull out the bucket 10 for use, one just grips a handle on the bucket lid 6 by hand and pulls it out with small force, and then the second bevel gear 5 is to be disengaged in line with the stirring direction. The vertical rotational shaft 4 will come free along the guide slot 8 in the gear bracket 1, and thus the second bevel gear 5 on the vertical rotational shaft 4 disengages from the first bevel gear 3 on the horizontal drive shaft 2.

If the bucket 10 is installed on the stirring rack 11, when stirring the paints in the bucket, the motor driver may drive the horizontal drive shaft 2 on the plurality of gear brackets 1 in series, which in turn drive the plurality of first bevel gears 3 to rotate. Due to the engagement between the first bevel gear 3 on the horizontal drive shaft 2 and the second bevel gear 5 on the vertical rotational shaft 4, the stirring paddle 7 on the vertical rotational shaft 4 also begins to rotate for stirring the paints. The location pin 13 on the bucket lid 6 is blocked at the second segment 8b of the guide slot to prevent the rotation of the bucket during the stirring process. Other means for preventing the rotation may be adopted. For a stirring unit without the bucket 10 inserted into the gear bracket 1, the first bevel gear 3 will rotate independently without interfering the normal operation of the stirring rack 11. In the stirring rack having this bevel gearing device, the buckets may be inserted and pulled out at any time as desired. Moreover, the separating configuration of the bevel gears may decrease the overall height of the stirring rack effectively, and thus the package and transport costs are reduced accordingly.

These and other modifications and variations to the present disclosure may be practiced by those of ordinary skill in the art, without departing from the spirit and scope of the present disclosure, which is more particularly set forth in the appended claims. In addition, it should be understood that aspects of the various aspects of the present disclosure may be interchanged either in whole or in part. Furthermore, those of ordinary skill in the art will appreciate that the foregoing description is by way of example only, and is not intended to limit the disclosure so further described in such appended claims.

What is claimed is:

1. A bevel gearing device suitable for the stirring rack of tinting machine, comprising:
a gear bracket (1) fixedly mounted on the stirring rack;
a horizontal drive shaft (2) rotationally mounted on the gear bracket (1);
a first bevel gear (3) fixedly mounted on the horizontal drive shaft (2) adjacent to a side of the gear bracket (1); and
a vertical rotational shaft (4) with a second bevel gear (5) fixedly mounted on its upper end and a stirring paddle (7) mounted on its lower end, and said stirring paddle (7) is placed in a paint bucket;
wherein an open guide slot (8) is provided at the bottom of the gear bracket (1), the guide slot (8) includes a first segment (8a) extending perpendicular to the horizontal drive shaft (2) and a second segment (8b) extending towards the first bevel gear (3), and the size of the guide slot is designed to slidably receive the vertical rotational shaft (4), such that the second bevel gear (5) is releasably engaged with the first bevel gear (3),
the rotation direction of the first bevel gear (3) is selected such that it drives the second bevel gear to rotate inward during the operation of the stirring rack, and
the first bevel gear and the second bevel gear are made of a plastic material.

2. The bevel gearing device according to claim 1, wherein an angle between the first segment and the second segment is α, and 180≧α≧160°, and the first bevel gear and the second bevel gear are configured such that a minimum value of gear backlash thereof increases along with an increasing value of the angle α.

3. The bevel gearing device according to claim 2, wherein the first bevel gear and the second bevel gear have a modulus m=1.5 to 4, and the minimum value of gear backlash is in the range of 0 mm to 0.3 mm.

4. The bevel gearing device according to claim 3, wherein the minimum value of gear backlash is 0 mm, if α=160°; or the minimum value of gear backlash is 0.3 mm, if α=180°.

5. The bevel gearing device according to claim 1, wherein the plastic material is mixed with an antifriction material.

6. The bevel gearing device according to claim 1, further comprising a reducer, and the rotation speed of the horizontal drive shaft (2) is adjusted from 60 to 95 rpm by the reducer.

7. The bevel gearing device according to claim 1, wherein the guide slot (8) has a width that achieves a loose fit between the guide slot and the vertical rotational shaft (4).

8. The bevel gearing device according to claim 6, wherein the first segment (8a) has a first width, the second segment (8b) has a second width, wherein the first width is larger than the second width.

9. The bevel gearing device according to claim 1, wherein the stirring paddle (7) is slidably installed on the vertical rotational shaft (4).

10. The bevel gearing device according to claim 1, wherein the horizontal drive shaft (2) and the vertical rotational shaft (4) are each made of a metal material.

11. The bevel gearing device according to claim 2, wherein the angle α is 170≧α≧160°.

12. The bevel gearing device according to claim 10, wherein the vertical rotational shaft (4) further comprises two segments which are connected together via thread.
